(19) United States
(12) Patent Application Publication
(10) Pub. No.: US 2006/0167911 A1
(43) Pub. Date: Jul. 27, 2006

(54) Automatic data pattern recognition and extraction

(76) Inventor: Stephane Le Cam, Verneuil sur seine (FR)

Correspondence Address: STERNE, KESSLER, GOLDSTEIN & FOX PLLC, 1100 NEW YORK AVENUE, N.W., WASHINGTON, DC, 20005, US

(21) Appl. No.: 11/040,111

(22) Filed: Jan. 24, 2005

(51) Int. Cl. G06F 7/00

(52) U.S. Cl. 707/101

(57) ABSTRACT

The present invention relates to a method and a computer program product for data pattern recognition and extraction. In one aspect, there is provided a computer implemented method for manually or automatically configuring a data extraction from one or more input files. In an embodiment, a user selects one or more input files for data extraction. In one embodiment, a user interface of the present invention allows the user to manually specify configuration parameters for the data extraction. In another embodiment, the present invention provides a plurality of heuristics to automatically detect data extraction areas located in one or more input files, automatically identify a layout type for each extraction area, and generate one or more data extraction outputs according to user-defined or pre-configured report types.

### FIELD OF THE INVENTION

The present invention relates generally to data pattern recognition and extraction. More particularly, the invention relates to a method and computer program product for data pattern recognition and extraction.

### BACKGROUND OF THE INVENTION

With increasing competition in the corporate world, companies are constantly striving to improve their market strategies. In one aspect, the efficient sharing and analysis of performance or market figures is essential to making sound business decisions.

In many situations, however, data is not readily available in a single document nor is it in a format that is easily analyzable. It is desired, for example, to have the data in a single database-compatible document, wherein interactive queries can be utilized to quickly and easily find specific data in the document. From another perspective, it is very important that any data extraction and/or consolidation method or computer program product require little configuration time from the part of the user.

For example, in a spreadsheet having defined rows and columns, such as an Excel spreadsheet, one or more data tables may be available. Data in the tables may or may not be related. However, it is desired, for example, to be able to merge related data in order to obtain a high-level understanding of the data comprised in the tables.

What is needed therefore is a method and a computer program product to extract data from one or more data files, and to consolidate the extracted data in database-compatible output formats. Further, a data extraction method and computer program product that reduce the data extraction configuration time are also needed.

### BRIEF SUMMARY OF THE INVENTION

The present invention relates to a method and a computer program product for data pattern recognition and extraction.

In one aspect of the invention, there is provided a computer implemented method for manually and/or automatically configuring a data extraction from one or more input files. A user selects one or more input files for data extraction. In one embodiment, a user interface of the present invention allows the user to manually specify configuration parameters for the data extraction. In another embodiment, the present invention provides a plurality of heuristics to automatically detect data extraction areas located in one or more input files, automatically identify a layout type for each extraction area, and generate one or more data extraction outputs according to user-defined or pre-configured report types. Further, the present invention comprises additional heuristics to merge data extracted from multiple extraction areas whenever the extracted data is logically related.

In another aspect of the present invention, the configuration parameters of a data extraction are converted into metadata, and associated with the input file of the data extraction. For subsequent data extractions from an updated version of the input file, the metadata is used to automatically extract data from the updated input file according to the previously configured data extraction, without the need for a manual re-configuration of the data extraction.

The invention can be practiced with, for example and without limitation, spreadsheets having defined rows and columns, such as Excel spreadsheets.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flowchart that illustrates a process for extracting data from one or more input files according to an embodiment of the present invention.

FIG. 2 is a screenshot of the user interface of the present invention that illustrates a first step of the process of FIG. 1.

FIG. 3 is a screenshot of the user interface of the present invention that illustrates a second step of the process of FIG. 1.

FIG. 4 is a screenshot of the user interface of the present invention that illustrates a previewing step of the process of FIG. 1.

FIG. 5 is a flowchart that illustrates a process for manually configuring a data extraction according to the present invention.

FIG. 6 is a screenshot of the user interface of the present invention that illustrates a step of the process of FIG. 5.

FIG. 7 is a screenshot of the user interface of the present invention that illustrates additional features of the process of FIG. 5.

FIGS. 8-12 are screenshots of the user interface of the present invention that illustrate selecting data axes in the process of FIG. 5.

FIG. 13 is a flowchart that illustrates a process for automatically configuring and extracting data from one or more input files according to the present invention.

The present invention will be described with reference to the accompanying drawings. The drawing in which an element first appears is typically indicated by the leftmost digit(s) in the corresponding reference number.

### DETAILED DESCRIPTION OF THE INVENTION

Overview

The present invention provides a method and a computer program product for automated data pattern recognition and extraction. In an embodiment of the present invention, the computer program product includes an execution module and a user interface.

The execution module comprises a plurality of sub-modules including sub-modules to identify table areas in a tabular data file, sub-modules to identify rows and columns in table areas, and sub-modules to extract data from the table areas. In another embodiment, the execution module also includes sub-modules to aggregate data extracted from one or multiple data files.

The user interface serves to customize a data extraction according to an extraction strategy provided by a user. In one embodiment of the present invention, the user interface receives a plurality of user inputs or configuration parameters that are used to configure a data extraction. The configuration parameters are relayed by the user interface to the execution module, which executes a data extraction based on the received configuration parameters. The result of the data extraction is then relayed back to the user through the user interface. Additional features of the execution module and the user interface will be set forth in the description that follows.

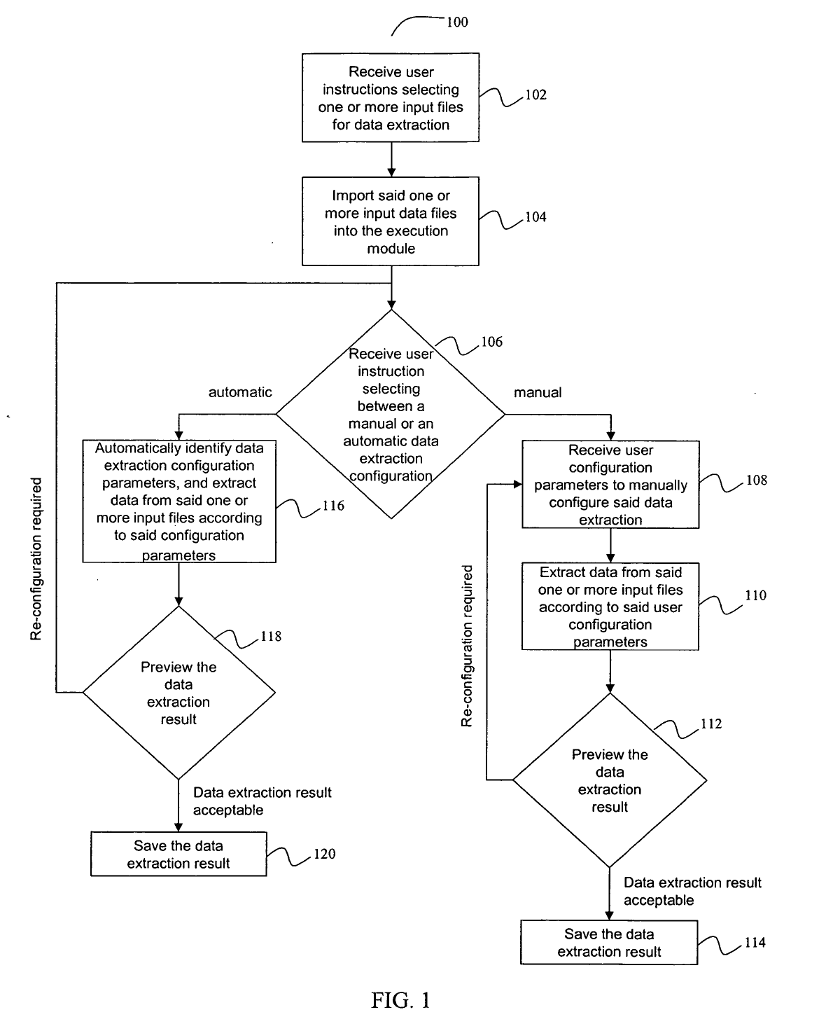

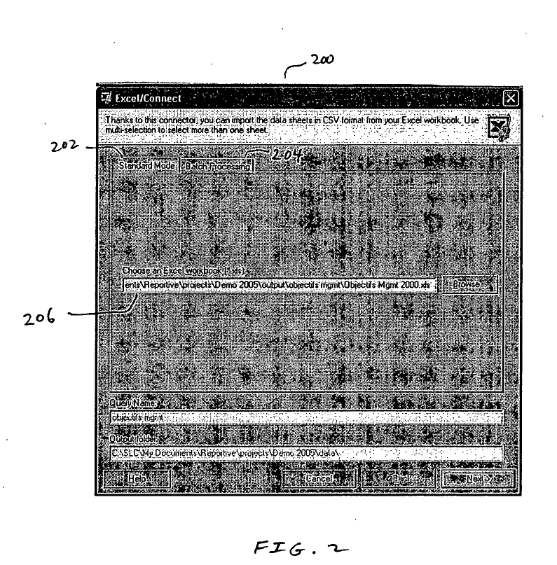

FIG. 1 is a flowchart that illustrates a process 100 for extracting data from one or more data files according to an embodiment of the invention. Process 100 starts at step 102. In step 102, a user selects one or more input data files for data extraction. In one embodiment, the present invention supports data extraction from one or more tabular data files, each tabular data file comprising one or more data tables. FIG. 2 illustrates a screenshot 200 of the user interface of the present invention that correspond to step 102. As can be noted from FIG. 2, the present invention supports data extraction from tabular data files that comprise spread sheets. For example, and without limitation, the present invention supports data extraction from Microsoft Excel spreadsheets.

In the example of FIG. 2, the screenshot 200 includes a plurality of selectable tabs, illustrated here as tabs 202 and 204. In FIG. 2, details associated with tab 202 are currently displayed. The details include a file selection field 206, which allows a user to select a desired tabular file to work with.

Typically, a tabular data file includes a plurality of data cells organized in rows and columns that define a plurality of data axes in the tabular data file. Data axes are used to classify data in the tabular data file. In one embodiment of the present invention, data axes in a tabular data file include at least one of a value, text, or time axis. Similarly, non-empty data cells in the tabular data file have value, text, or time data types. As can be understood by a person skilled in the art(s), a non-empty data cell having a value type belongs to a value data axis, for example. In another embodiment, a data axis comprises both empty and non-empty data cells. In another embodiment of the present invention, a tabular data file has a flat or a matrix layout. In a flat layout, each data column is associated with a single data axis and holds data of a common type. Further, a header row of the tabular data file defines names for the data axes in the file. In a matrix layout, however, each data column of value type is associated with a plurality of data axes.

Referring back to FIG. 1, in step 104, the one or more tabular data files selected in step 102 are imported into the execution module. By importing the selected tabular data files, the execution module can now access the data in the tabular data files. In one embodiment of the present invention, the selected one or more tabular data files are accessed and data from the one or more tabular data files are copied into a memory storage accessible by the execution module.

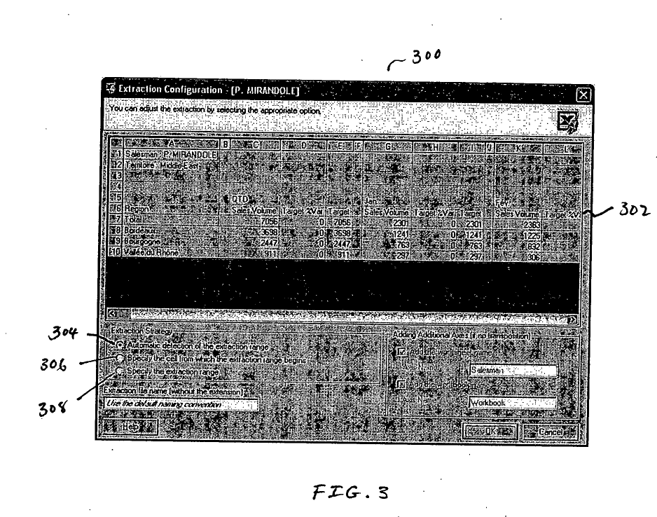

In step 106, the user selects between a manual or an automatic data extraction configuration. FIG. 3 illustrates a screenshot 300 of the user interface that corresponds to step 106. The screenshot 300 includes a viewable area 302 of a selected tabular file. The screenshot 300 also includes a set of selectable buttons, including buttons 304, 306, and 308. Button 304 corresponds to an automatic detection of the data extraction range. Buttons 306 and 308 correspond to manual options for specifying the extraction range.

If a manual configuration is selected in step 106, process 100 branches to step 108. In step 108, the user manually configures the data extraction. In an embodiment, the user interface receives user configuration parameters specifying a data extraction area and data axes for the data extraction. Data is then extracted, in step 110, according to the configuration parameters received from the user in step 108.

If an automatic configuration is selected in step 106, process 100 branches to step 116. In step 116, configuration parameters that define a data extraction are automatically detected by the execution module. Data will be then automatically extracted from the one or more input data files. It is to be noted here that when an automatic configuration is selected, tasks relating to the data extraction are performed by a computer process without intervening user instructions. Additional features and advantages of each of the manual and automatic configuration will be set forth in the description that follows.

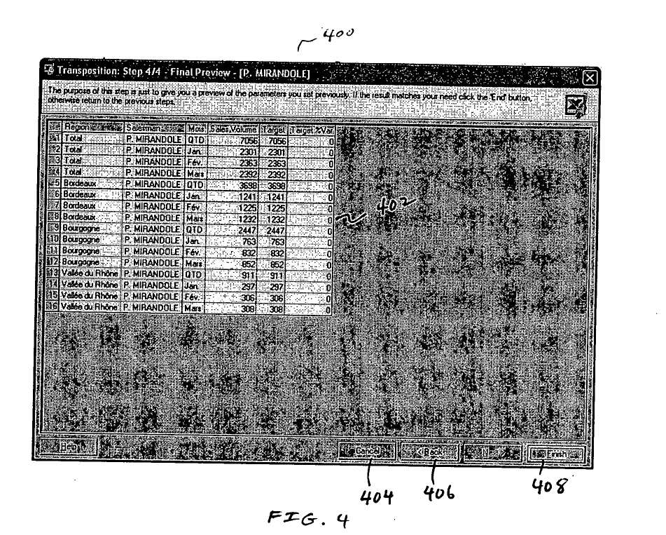

In steps 112 and 118, the user can preview the result of the data extraction. FIG. 4 illustrates a screenshot 400 of the user interface that corresponds to step 112 and 118. The screenshot 400 include a viewable area 402 that shows the result of the data extraction. The screenshot 400 also includes a set of selectable buttons 404, 406, and 480. As is apparent to a person skilled in the art(s), button 404 allows the user to cancel the current data extraction. In a manual configuration, button 406 allows the user to re-configure the data extraction. If the data extraction result is acceptable to the user, however, button 408 allows the user to finalize the configuration and to extract data accordingly.

In an embodiment, the user refines configuration parameters upon previewing the result of the data extraction. In another embodiment, the user modifies the type of the data extraction configuration after previewing the result of the data extraction. In an exemplary embodiment, the user selects a manual data extraction configuration upon previewing the result of a previous automatic data extraction configuration.

If, after previewing the results of the data extraction in step 112 and/or 118, the user finds the result of the data extraction acceptable, the user saves the result of the data extraction in step 114 or 120. The extracted data is saved into an output file specified by the user. In an embodiment, the output file has a flat layout compatible with database use.

In another aspect of the present invention, upon saving the result of a data extraction, the configuration parameters of the data extraction are converted into metadata which is associated with the input data file. In an embodiment of the present invention, for each subsequent data extraction from an updated version of the input file, the metadata is used to automatically extract data from the updated input file according to the previously configured data extraction. In other words, a data extraction re-configuration is not needed for a future data extraction from an updated version of the input file. According to the present invention, an updated version of the input file can have modified values and/or formatting of data cells, new rows corresponding to new text axes, and new columns corresponding to new time and/or value axes.

Manual Data Extraction

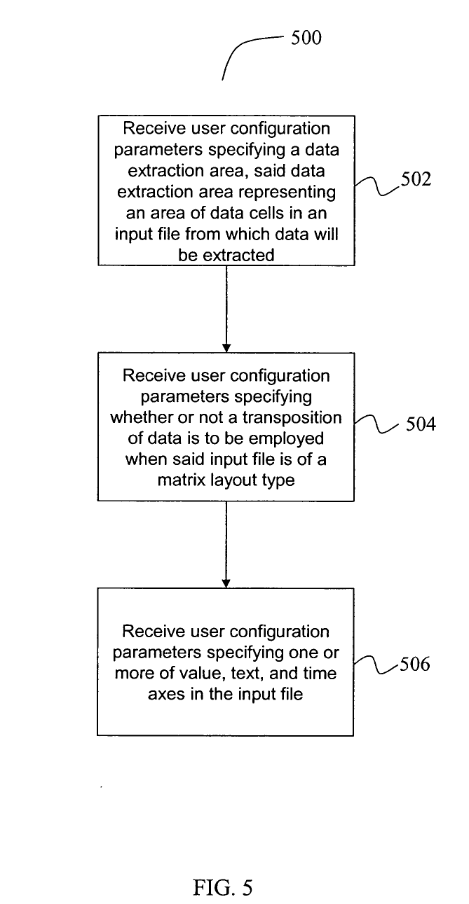

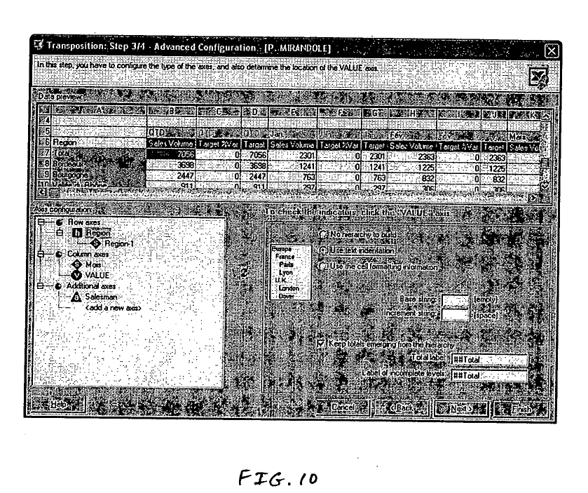

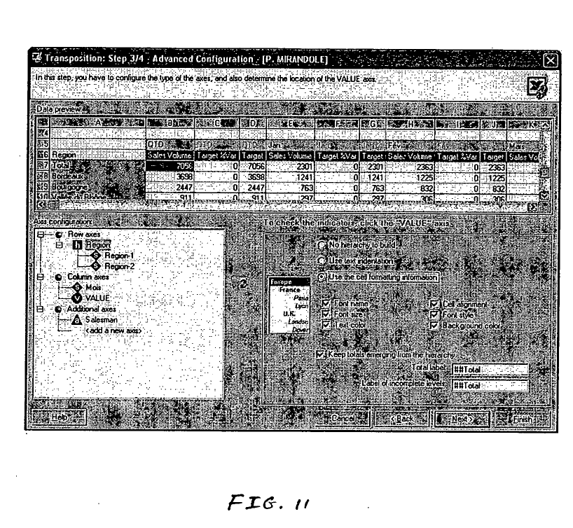

FIG. 5 is a flowchart that illustrates an example process 500 for manually configuring a data extraction according to the present invention. The process of FIG. 5 includes steps 502, 504, and 506, and will now be described with reference to FIGS. 5-12.

In step 502, the user inputs configuration parameters to specify a data extraction area. The data extraction area defines an area of data cells from which data will be extracted. In an embodiment of the present invention, specifying the data extraction can be done by either specifying a range of data cells or an extraction starting cell. In specifying a range of data cells, the data extraction area corresponds to the specified range. In specifying a starting cell, the data extraction area corresponds to all data cells below and to the right of the starting cell.

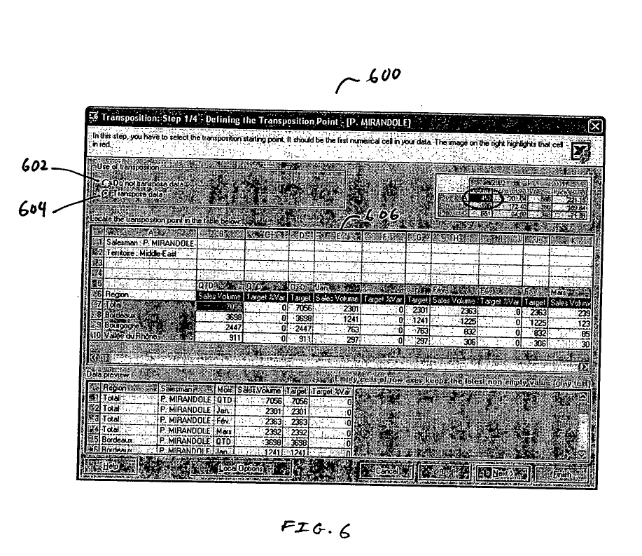

In step 504, the user selects whether a data transposition is to be employed in the data extraction. FIG. 6 illustrates a screenshot 600 of the user interface that corresponds to step 504. Screenshot 600 includes, among other features, selectable buttons 602 and 604 and an active area 606. Buttons 602 and 604 allow the user to select whether to transpose the data or not. Typically, a transposition of data transforms the dimensions of the extracted data, and applies when the data being extracted comprises tables having a matrix layout. As noted from FIG. 6, as part of selecting a transposition of data, the user also selects a data transposition point by selecting a data cell in active area 606. The data transposition point defines a starting point for the transposition. In an embodiment of the present invention, the data transposition point corresponds to the top left cell having a value type in the input file. Other transposition features, according to the present invention, include features relating to keeping or suppressing empty rows/columns in the data extraction area.

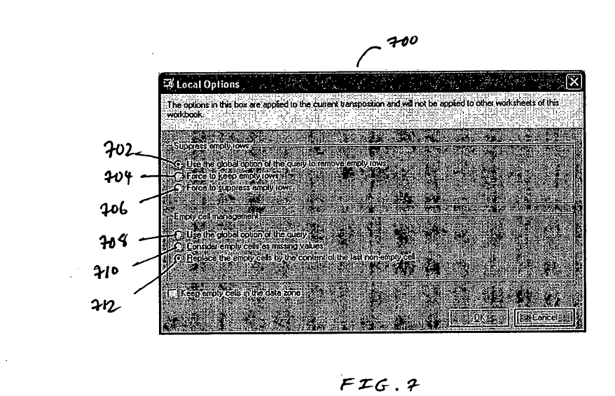

FIG. 7 illustrates a screenshot of the user interface showing those features. In screenshot 700, selectable buttons 702, 704, and 706 provide user options related to handling empty rows during the data extraction. Among available options, the user may use a global option to keep or remove empty rows, force to keep empty rows, or force to suppress empty rows. Similarly, selectable buttons 708, 710, and 712 provide user options related to handling empty cells during the data extraction. Among available options, the user may use a global option to handle empty cells, consider empty cells as missing values, or replace empty cells with the content of the last non-empty cell.

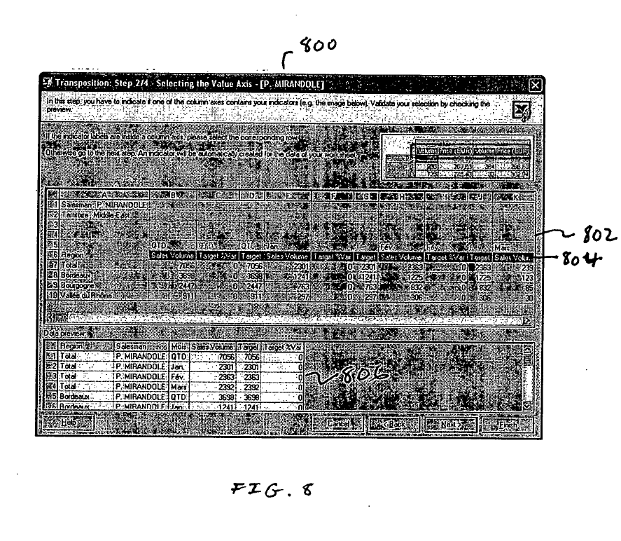

Referring back to FIG. 5, in step 506, the user inputs configuration parameters to specify data axes for the data extraction. As described above, a data axis corresponds to one of a value, text, or time axis. Typically, a value axis relates logical connections between one or more text and/or time axes. FIGS. 8-12 illustrate screenshots of the user interface that correspond to step 506. FIGS. 8-12 are described below.

FIG. 8 illustrates a screenshot 800 of the user interface that shows the selection of value axes in the depicted exemplary embodiment. Among other features, screenshot 800 includes an active area 802 and a preview area 806. According to an embodiment of the present invention, selecting a value axis is done by selecting a header cell that corresponds to it. In the example of FIG. 8, several value axes are selected by highlighting a corresponding header row 804 in active area 802. In doing that, the names of the value axes in the data extraction output correspond respectively to the names of the header row cells in the input file. This can be noted in the preview area 806 of screenshot 800. When a header row cell name is not defined, however, a name for the corresponding value axis is deduced based on the content type of the value axis. Table 1 describes a few exemplary rules that can be used to deduce a name for a value, text, or time axis:

TABLE 1

| Rule | Axis Name | Axis Type |
|---|---|---|
| Date format (day, month, | Date1, Date2, etc. | Time |
| quarter, etc.) | | |
| Percentage values | % of | Value |
| Geographical names | Country, Region, City, etc. | Text |
| (country, region, city, etc.) | | |

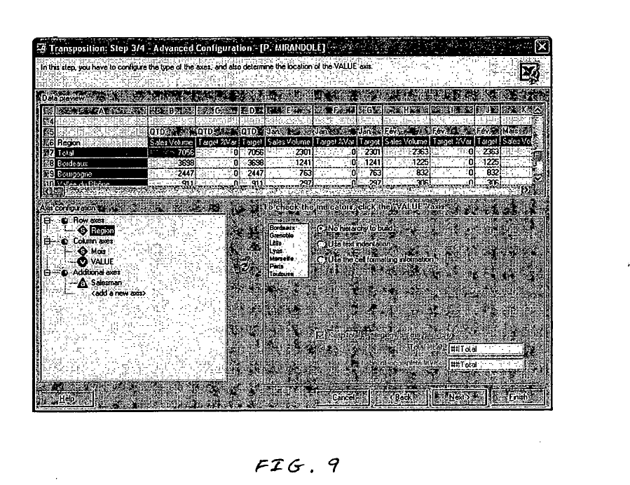

FIGS. 9-12 illustrate screenshots of the user interface that depict the selection of value, text and/or time axes according to an exemplary embodiment of the present invention. As can be noted from FIG. 9, the selection of a text axis is done by selecting a corresponding header column. In the example of FIG. 9, the text axis corresponds to a “Region” axis. Similar to selecting a value axis, selecting a time axis is done by selecting a corresponding header row. In the example of FIG. 9, the time axis corresponds to a “Month” axis.

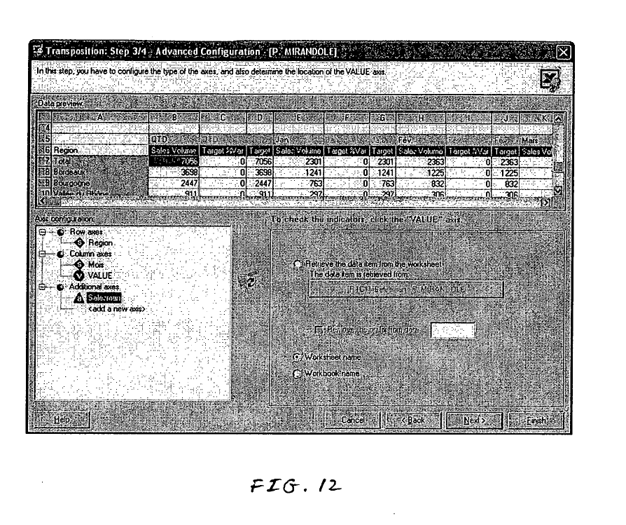

In another aspect, the present invention provides several optional features relating to shaping the structure of the output of the data extraction. For example, in cases where the text axis comprises a logical hierarchy, the present invention provides user options to reflect that hierarchy in the data extraction output. In embodiments of the present invention, text indentation and cell formatting information in a text axis are used to detect the different levels of hierarchy in the text axis. FIGS. 9-11 illustrate those features of the present invention. Another feature of the present invention, illustrated in FIG. 12, allows the selection of additional data axes not within the selected input files. In the exemplary embodiment of FIG. 12, a “Salesman” axis is added based on a name of the input file.

At the end of the data axes configuration step, the data extraction is fully configured to be executed. As described earlier, a preview feature of the present invention allows the user to preview the expected data extraction output before completing the extraction. In embodiments of the present invention, various pre-defined output formats are also available for selection by the user at the beginning of the configuration.

Automatic Data Extraction

In another aspect, the present invention provides a method for automatically extracting data from an input file. According to this aspect, the invention provides a plurality of heuristics to automatically detect data extraction areas located in one or more input files, automatically identify data axes within each detected extraction area, and generate one or more extraction outputs according to user-defined or pre-configured report types. Further, the present invention comprises additional heuristics to merge data extracted from multiple extraction areas whenever the extracted data is logically related.

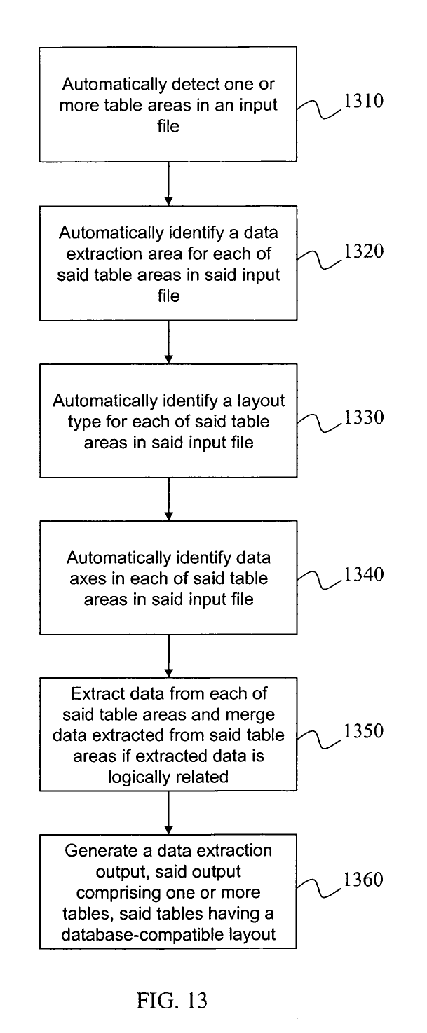

FIG. 13 is a flowchart that illustrates a process for automatically configuring and extracting data from one or more input files according to the present invention. The process of FIG. 13 starts at step 1310. It is assumed that, at step 1310, one or more input files have been selected by the user for automatic data extraction. The first step of the automatic extraction process is to detect any data extraction or table areas within the selected one or more input files. As it can be understood by a person skilled in the art(s), a single input file may comprise a plurality of table areas. For example, a Microsoft Excel document may comprise a plurality of table areas located on the same spreadsheet or on separate spreadsheets within the same document. According to a heuristic of the present invention, cell formatting information of the input file is used to detect table areas within an input file. In an embodiment, empty rows and columns in an input file are considered as delimiters between table areas in the file.

Once table areas are detected in the input file in step 1310, the exact range of each table area is identified in step 1320. In an embodiment of the present invention, starting at a non-empty cell of a table area, adjacent cells (top, bottom, left, right) are evaluated to find a non-empty cell. If an adjacent non-empty cell is found, the evaluation continues at that cell. Otherwise, the recursion stops. Cells determined non-empty at the end of the recursion define the exact range of the table area. At each point of the recursion, non-empty cell positions corresponding to the top left, top right, bottom left, and bottom right positions are updated and recorded. In another embodiment, if the input file is of a rich file format such as a Microsoft Excel document, for example, range names, if defined, can be used to detect the exact range of a table area in the input file. Typically, range names are user-defined names that refer to a range of data cells.

Having identified the table areas in steps 1310 and 1320, the next step 1330 is to identify a layout type for each table area in the input file. As, typically, a table area comprises header cells and data cells, identifying a layout type for the table area amounts to determining the different cell areas in the table.

According to an embodiment of the present invention, each table area in the input file is evaluated against a plurality of table layout types. An evaluation score is calculated for each layout type, and the layout type corresponding to the maximum evaluation score is identified as a layout type for the table area. Typically, a number of layout parameters are associated with each layout type. Layout parameters are parameters that characterize a layout. In a flat table layout, for example, a “header row” is one of the characteristic layout parameters. As can be understood by a person skilled in the art(s), a number of layout parameters may be general to more than one layout type, while others are layout-specific. We refer to general layout parameters as first level layout parameters, and to layout-specific parameters as second level layout parameters in what follows. Additional features of the heuristic method used for table area layout recognition will now be described.

In a first step, a set of first level layout parameters are located in the table area. In an embodiment, the set of first level layout parameters include a top left data cell. Typically, the top left data cell indicates a starting cell for a header row in the table area. In an embodiment of the present invention, locating a first level layout parameter in a table area is done by evaluating each cell in the table area against a set of rules associated with the layout parameter. Typically, the set of rules associated with a layout parameter characterize location and formatting information of the parameter. However, although first level layout parameters are general to all layout types, the evaluation rules associated with them can be different from one layout type to another. Tables 2 and 3 illustrate an example of layout parameter rules for the “top left data cell” in a flat and a matrix layout, respectively.

TABLE 2

| Rule | Weight |
|---|---|
| Left cell is empty | 1 |
| Upper cell is empty | 0.5 |
| Upper cell is non empty but has a different cell formatting | 0.5 |
| Upper cell is empty | 0.5 |
| Top left border (discontinuity on left and upper directions) | 1 |
| Right cell is non empty | 0.5 |
| Right cell contains text | 1 |
| Right cell is empty but has very small width (possibly a break) | 0.5 |

TABLE 3

| Rule | Weight |
|---|---|
| Cell is empty | 0.5 |
| Left cell is empty | 0.5 |
| Upper cell is empty | 0.5 |
| Right cell is non-empty | 0.5 |
| Right column is text (starting first non-empty cell) | 1 |
| Bottom cell is non-empty | 0.5 |
| Bottom right cell is non-empty | 1 |
| Top left border (discontinuity on left and upper directions) | 1 |

In an embodiment of the present invention, when locating a first level layout parameter, each data cell in the table area is evaluated, in parallel, with respect to the layout parameter rules of each of the plurality of layout types. As a result, for each layout type, a weight is calculated for each data cell in the table area with respect to the layout parameter. The weight represents a likelihood that the data cell corresponds to the layout parameter in the table area. In an embodiment, data cells having a weight higher than a pre-defined threshold are remembered as potential candidates for the layout parameter. A data cell having the maximum weight is selected as the layout parameter. As it is apparent to a person skilled in the art(s), the data cell corresponding to the maximum weight may or may not be the same data cell for all layout types.

In a second step of the layout recognition heuristic, a set of second level layout parameters are located in the table area. The objective is that, in locating the second level layout parameters of a layout type, the layout type can be either validated or removed from consideration as a potential layout type for the table area.

Typically, first and second level layout parameters allow the full characterization of a data extraction area in a table area according to a layout type. Second level layout parameters, however, are not independent from first level layout parameters. In a flat layout type, for example, the “header row ending cell” is one of second level layout parameters of the layout type. The “header row ending cell” is related, however, to the “top left data cell”, a first level layout parameter. This is true because the “top left data cell” defines the starting cell of a header row, and therefore, both parameters should occur on the same row level.

As a result of this dependence between first level and second level layout parameters, locating second level layout parameters of a layout type must be done based on a set of first level layout parameters. Accordingly, when locating a second level layout parameter, a set of first level layout parameters is assumed, and the second level layout parameter is located based on it. As a result, only data cells that may correspond to the second level layout will be considered. For example, in a flat layout type, when locating a “header row ending cell”, only data cells located on the same row level as the “top left data cell” will be evaluated.

In an embodiment of the present invention, the data cells corresponding to the maximum weight for first level layout parameters, in the first step, are initially assumed. Based on them, second level layout parameters are located in the table area using a rule-based evaluation approach similar to the one described above with respect to first level parameters. If second level layout parameters are successfully located based on the assumed first level layout parameters, the data cells corresponding to the maximum weights for both the first and second level layout parameters are selected as first and second level layout parameters for the table area. If second level layout parameters could not be located, however, the location process is repeated with respect to the data cells having the second highest weights for first level layout parameters in the first step. As can be understood by a person skilled in the art(s), the process of locating second level layout parameters based on first level layout parameters can be recursively repeated until second level layout parameters are successfully located or the list of potential candidates for first level layout parameters is exhausted. Also, as is apparent to a person skilled in the art, second level layout parameters are successfully located when the evaluation process results in a set of data cells having evaluation weights higher than a pre-defined threshold.

After locating first and second level layout parameters for each layout type in a table area, a match probability is calculated for each layout type. The match probability is defined as the probability that the layout type matches the layout of the table area. The layout type having the maximum match probability is selected as the layout for the table area.

At this point of the automatic data extraction process, table areas have been detected and their extraction areas and layout types identified. Referring back to FIG. 13, in step 1340, data axes are identified for each table area in the input file. In particular, step 1340 comprises identifying a name and a type for each data axis in a table area. As described earlier with respect to the manual data extraction configuration, the names of header row cells typically define the names of the data axes in a table area. Accordingly, in an embodiment of the present invention, the names of data axes are extracted from the names of header row cells of the table area. When names of header row cells are not defined, however, names can be deduced based on the data content of each data axis. In another embodiment of the present invention, one more data axes of table area are hierarchical axes comprising a plurality of axis levels. A feature heuristic of the present invention identifies the different levels in a hierarchical axis. In one embodiment, cell formatting, indentation, and/or prefix patterns are analyzed in the hierarchical axis. In another embodiment, a dictionary is used to detect hierarchical levels of a hierarchical axis. Table 4 illustrates an example of a hierarchical data axis. Absent formatting, indentation, and prefix information, a dictionary is consulted to determine that the axis of Table 4 includes three axis levels. Further, using the dictionary, a name can be deduced for each of the axis levels of the hierarchical axis. In the example of Table 4, a “Continent”, “Country”, and “City” axis may be deduced.

TABLE 4

Europe
France
Paris
UK
London

In step 1350, data is extracted from each of the table areas identified in the previous steps of the process. When data is extracted from a plurality of table areas in the input file, the extracted data may be merged together in the data extraction output. In an embodiment, data extracted from multiple table areas are analyzed to determine logical associations among them. In another embodiment, names of data axes are compared to determine if the data can be related.

In step 1360, an output of the automatic data extraction is generated. The output may comprise one or more tables depending on whether or not data is merged in the previous step. In an embodiment, generated output tables have a flat layout type compatible with database use. As described earlier with regard to the manual data extraction configuration, a preview feature of the present allows the user the ability to preview the expected data extraction output before completing the extraction. In embodiments of the present invention, various pre-defined output formats are also available for selection by the user at the beginning of the configuration.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A computer implemented method for data extraction from a tabular data file, comprising:
(1) receiving a first user instruction selecting a tabular data file;
(2) receiving a second user instruction selecting between a manual or an automatic data extraction configuration;
(3) receiving user configuration parameters to configure said data extraction when a manual configuration is selected;
(4) automatically generating the configuration parameters when an automatic configuration is selected;
(5) converting the configuration parameters into metadata and associating said metadata with said tabular data file;
(6) extracting data from said tabular data file according to said configuration parameters; and
(7) for each subsequent data extraction from an updated version of said tabular data file, using said metadata to automatically extract data from said updated tabular data file according to said data extraction configuration, thereby bypassing steps (2)-(6).

2. The method of claim 1, wherein said tabular data file includes a plurality of data cells organized in rows and columns, said rows and columns defining axes, said axes used to classify data in said tabular data file.

3. The method of claim 2, wherein each data cell is either empty or non-empty, non-empty data cells having a value, text, or time data type.

4. The method of claim 3, wherein said axes include at least one of a value axis, a text axis, or a time axis.

5. The method of claim 4, wherein said tabular data file is of a flat layout type, and wherein each data column in said tabular data file is associated with a single axis and holding data of a common type.

6. The method of claim 5, wherein a header row of said tabular data file defines axes names.

7. The method of claim 4, wherein said tabular data file is of a matrix layout type, each data column of value type associated with a plurality of axes.

8. The method of claim 1, wherein said tabular data file comprises a spread sheet.

9. The method of claim 8, wherein said tabular data file comprises a Microsoft Excel spread sheet.

10. The method of claim 2, wherein step (3) comprises:
(a) receiving user configuration parameters specifying a data extraction area; and
(b) receiving user configuration parameters specifying data axes for the data extraction.

11. The method of claim 10, wherein step (3) further comprises:
(c) receiving user configuration parameters specifying a transposition of data when said tabular data file is of a matrix layout type, said transposition of data transforming dimensions of said tabular data file; and
(d) receiving user configuration parameters specifying a data transposition starting point.

12. The method of claim 10, wherein step (3)(a) comprises receiving user configuration parameters specifying one of:
a range of data cells, wherein said data extraction area corresponds to said range; and
a starting cell, wherein said data extraction area corresponds to data cells below and to the right of said starting cell.

13. The method of claim 10, wherein step (3) further comprises:
(e) receiving user configuration parameters specifying one or more of value, text, and time axes; and
(f) receiving user configuration parameters specifying additional data axes.

14. The method of claim 13, wherein specifying a value and/or a time axis comprises selecting a header row corresponding to said axis.

15. The method of claim 13, wherein specifying a text axis comprises selecting a header column corresponding to said axis.

16. The method of claim 15, further comprising:
(g) receiving user instructions specifying whether a text indentation or a cell formatting in said header column is used to hierarchically classify data corresponding to said text axis.

17. The method of claim 2, wherein step (4) comprises:
(a) automatically detecting one or more table areas in said tabular data file, said table areas having data in tabular format;
(b) automatically detecting a data extraction area in each of said table areas; and
(c) automatically identifying data axes in each of said table areas in said tabular data file.

18. The method of claim 17, wherein step (4)(b) comprises:
(i) using range names to detect a data extraction area in a table area, said range names being user-defined names that refer to a range of cells; or
(ii) automatically recognizing a layout type for said table area to detect said data extraction area.

19. The method of claim 18, wherein step (4)(b)(ii) comprises:
evaluating a layout of said table area against a plurality of layout types; and
identifying a layout type corresponding to a maximum evaluation score as a layout type for said table area.

20. The method of claim 19, wherein said evaluating step further comprises, for each layout type of said plurality of layout types:
locating a set of first level layout parameters in said table area;
locating, according to said set of first level layout parameters, a set of second level layout parameters in said table area, wherein said set of second level layout parameters validates said layout type in said table area; and
calculating a probability that said layout type matches the layout of said table area.

21. The method of claim 20, wherein said set of first level layout parameters includes layout parameters that are general to all layout types in said plurality of layout types.

22. The method of claim 21, wherein said set of first level layout parameters includes a top left non-empty data cell, said data cell also indicating a starting cell for a header row.

23. The method of claim 20, wherein said set of second level layout parameters includes layout parameters that are specific to a layout type and define a data extraction area according to said layout type.

24. The method of claim 23, wherein said set of second level layout parameters includes an ending cell for a header row in a flat layout type.

25. The method of claim 23, wherein said set of second level layout parameters includes a data transposition point, header rows, header columns, ending cells of header rows, and ending cells of header columns in a matrix layout type.

26. The method of claim 20, wherein a set of rules are associated with each layout parameter in said set of first or second level layout parameters, said set of rules characterizing location and formatting information of said layout parameter.

27. The method of claim 26, wherein each of said locating steps further comprises:
for each layout parameter, evaluating said set of rules associated with said layout parameter at every data cell in said table area; and
selecting a data cell corresponding to a maximum evaluation score as said layout parameter.

28. The method of claim 27, wherein said locating a set of second level layout parameters further comprises:
if, for said set of first level layout parameters, said set of second level layout parameters cannot be located, locating said set of second level layout parameters according to data cells having a second best evaluation score for first level layout parameters in said evaluating step.

29. The method of claim 28, wherein said evaluating said set of rules further comprises:
in locating first level layout parameters, recording data cells having an evaluation score above a defined threshold, wherein said threshold is used to limit potential sets of first level layout parameters that can be further considered in locating said set of second level layout parameters.

30. The method of claim 26, wherein a new layout type is added to said plurality of layout types by adding metadata that describes a set of second level layout parameters and evaluation rules thereof associated with said new layout type.

31. The method of claim 17, wherein step (4)(c) comprises:
identifying a name and a type for each data axis in said data extraction area.

32. The method of claim 31, wherein said identifying step further comprises, for each data axis in said extraction area:
(i) determining if said data axis is a flat or a hierarchical axis, wherein a flat axis contains data of a single level, wherein a hierarchical axis contains data of multiple levels;
(ii) if said data axis is a flat axis, using a name of a cell in a header row of said tabular data file corresponding to said data axis to define a name for said data axis;
(iii) if said data axis is a hierarchical axis, using cell formatting, indentation, and/or prefix information of corresponding header columns to determine names for hierarchical levels in said data axis; and
(iv) determining a type for said data axis based on data content of cells in said axis.

33. The method of claim 32, wherein step (ii) further comprises:
if the name of said cell in said header row is not defined, deducing a name for said cell based on data content type in said axis.

34. The method of claim 17, wherein step (4) further comprises:
(d) merging data from said one or more table areas if said data is logically related to form a merged table area.

35. The method of claim 34, wherein step (d) comprises:
(i) comparing header information of said one or more table areas to determine if said one or more table areas include logically related data;
(ii) analyzing content type of data axes in each of said one or more data table areas when said header information is not available; and
(iii) when said one more table areas are divided based on a logical axis in said tabular data file, adding said logical axis in the merged table area.

36. The method of claim 1, wherein step (6) further comprises:
(a) copying data from said one or more table areas in said tabular data file according to said data extraction configuration; and
(b) generating one or more new data files having a flat table layout compatible with database use, said new data files containing data extracted from said one or more table areas in said tabular data file according to said data extraction configuration.

37. The method of claim 1, wherein a manual data extraction re-configuration is not needed for a subsequent data extraction from an updated version of said tabular data file if:
values of data cells are changed in said updated tabular data file; or
formatting of data cells is modified in said updated tabular data file; or
rows corresponding to new text axis entries are added in said updated tabular data file; or
columns corresponding to new time axis entries are added in said updated tabular data file; or
columns corresponding to new value axis entries are added in said updated tabular data file.

38. A computer implemented method for data extraction from a plurality of tabular data files, comprising:
receiving user instructions selecting a plurality of tabular data files;
extracting data according to a manual or an automatic extraction configuration from each of said plurality of tabular data files, respectively;
consolidating data extracted from said plurality of tabular data files to generate a single data file having a layout compatible with database use; and
generating metadata defining said extraction configuration and associating said metadata with said plurality of tabular data files, said metadata used to automatically extract data from said plurality of tabular data files in future data extractions.
